(19) United States
(12) Patent Application Publication
(10) Pub. No.: US 2020/0336841 A1
(43) Pub. Date: Oct. 22, 2020

(54) Microelectromechanical System (MEMS) Comprising Microphone and Low Power Circuitry with Detection of Audio Signal

(71) Applicant: Robert Bosch GmbH, Stuttgart (DE)

(72) Inventors: Matthew Zeleznik, Pittsburgh, PA (US); Axel Kaschner, Wexford, PA (US)

(21) Appl. No.: 16/095,767

(22) PCT Filed: May 10, 2017
(86) PCT No.: PCT/EP2017/061133

§ 371 Date: Oct. 23, 2018

Related U.S. Application Data
(60) Provisional application No. 62/334,190, filed on May 10, 2016.

(51) Int. Cl. H04R 19/04

(52) U.S. Cl. CPC H04R 19/04; H04R 2201/003

(57) ABSTRACT

A MEMS sensor system and method of operation is provided. The MEMS sensor system comprises a sensor device having a movable member and a sensor circuitry communicatively coupled the sensor device to at least one or more terminals. The sensor circuitry comprises a sensor ASIC and an analog signal processor coupled to least one of the sensor ASIC, the sensor device, and the terminal. The sensor ASIC is configured to operate either at a full performance mode after an audio signal is detected or at a lower power mode when the audio signal is not detected. A preamplifier coupled to the sensor device is configured to output a signal indicative of acoustic pressures on the movable member is provided. The sensor circuitry further comprises a sigma-delta modulator communicatively coupled to the preamplifier. When a target audio signal is detected by the analog signal processor, a control signal is sent to the sensor ASIC to set the preamplifer to full performance mode and to power on the sigma-delta converter. When a target audio signal is not detected by the analog signal processor, the control signal to the sensor ASIC sets the preamplifier to low performance mode and powers down the sigma delta converter. The sensor ASIC and the audio signal processor may be either in a three-dimensional chip stacked configuration or integrated together to form a single sensor circuitry.

### CROSS-REFERENCE TO RELATED APPLICATION

This application claims priority to a U.S. provisional patent application Ser. No. 62/334,190, filed May 10, 2016, the contents of which are incorporated herein by reference as if fully enclosed herein.

### FIELD

This disclosure relates to microelectromechanical system (MEMS) sensor device, particularly, to an analog signal processing system for a MEMS sensor device.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure related to MEMS sensor system and method of operation. For example, the MEMS sensor system comprises a sensor device having a movable member and a sensor circuitry communicatively coupled the sensor device to at least one or more terminals. The sensor circuitry comprises a sensor ASIC and an analog signal processor coupled to least one of the sensor ASIC, the sensor device, and the terminal. The sensor ASIC is configured to operate either at a full performance mode or at a low performance mode. A preamplifier coupled to the sensor device is configured to output a signal indicative of acoustic pressures on the movable member is provided. The sensor circuitry further comprises a sigma-delta modulator communicatively coupled to the preamplifier. When a target audio signal is detected by the analog signal processor, a control signal is sent to the sensor ASIC to set the preamplifer to full performance mode and to power on the sigma-delta converter. When a target audio signal is not detected by the analog signal processor, the control signal to the sensor ASIC sets the preamplifier to low performance mode and powers down the sigma delta converter. The sensor ASIC and the audio signal processor may be either in a three-dimensional chip stacked configuration or integrated together to form a single sensor circuitry.

### BRIEF DESCRIPTION OF THE DRAWINGS

These and other features, aspects, and advantages of this disclosure will become better understood when the following detailed description of certain exemplary embodiments is read with reference to the accompanying drawings in which like characters represent like arts throughout the drawings, wherein:

FIG. 1 is a perspective view of an exemplary MEMS device package in accordance with embodiments of the disclosure;

FIG. 2 is a schematic block diagram of an exemplary MEMS device package with a low power sensor circuitry in accordance with a described embodiment of the disclosure;

FIG. 3 is a cross-sectional view of the MEMS device package of FIG. 2 in accordance with a described embodiment of the disclosure;

FIG. 4 is a schematic block diagram of an exemplary MEMS device package with a lower power sensor circuitry in accordance with another described embodiment of the disclosure;

FIG. 5 is a cross-sectional view of the MEMS device package of FIG. 4 in accordance with another described embodiment of the disclosure;

FIG. 6 is a schematic diagram of an exemplary digital MEMS sensor system with a low power sensor circuitry in accordance with another described embodiment of the disclosure;

FIG. 7 is a schematic diagram of an exemplary digital MEMS sensor system with a low power sensor circuitry in accordance with another described embodiment of the disclosure;

FIG. 8 is a schematic diagram of an exemplary differential analog MEMS sensor system with a low power sensor circuitry in accordance with another described embodiment of the disclosure; and

FIG. 9 is a schematic diagram of an exemplary differential analog MEMS sensor system with a low power sensor circuitry in accordance with another described embodiment of the disclosure.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

A client machine may be provided with electronic components, such as sensor devices, speakers, graphical processor units, computer processor units, and any suitable computer implemented devices. The client machine may be a personal computer or desktop computer, a laptop, a cellular or smart phone, a tablet, a personal digital assistant (PDA), a gaming console, an audio device, a video device, an entertainment device such as a television, a vehicle infotainment, a wearable device, a thin client system, a thick client system, or the like.

The sensor devices may be provided that include a package or an enclosure for housing one or more sensors, internal components, or combination thereof. The sensors may be such as MEMS transducers, speakers, receivers, microphones, pressure sensors, thermal sensors, optical sensors, imaging sensors, chemical sensors, gyroscopes, humidity sensors, accelerometers, gas sensors, environmental sensors, motion sensors, navigation sensors, or proximity sensors, or bolometers. The microphones may be electret microphones, capacitive microphones, piezoelectric microphones, silicon microphones, or any suitable acoustic microphones.

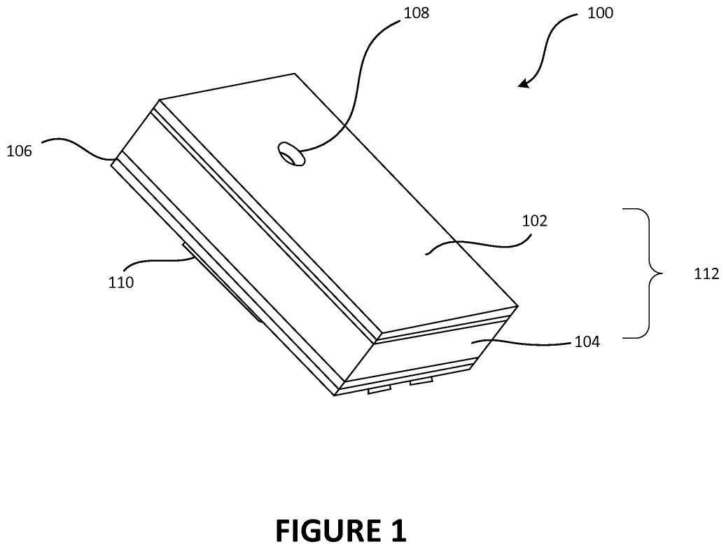

FIG. 1 is a perspective of a MEMS device package 100 according to an exemplary embodiment of the disclosure. The package 100 may reside in any client machines includes a lid 102, a spacer 104, and a substrate 106 attached to the spacer 104 by any suitable methods of attachment. One or more sensors and/or internal components may be housed within the package 100. The sensors may be such as MEMS transducers, speakers, receivers, microphones, pressure sensors, thermal sensors, optical sensors, imaging sensors, chemical sensors, gyroscopes, humidity sensors, accelerometers, gas sensors, environmental sensors, motion sensors, navigation sensors, or proximity sensors, or bolometers. The internal components may be integrated circuits, ASICs, processors, controllers, energy storage devices, sensor circuitry systems, and any suitable components. Depending on the application, an optional port 108 may be formed on the package 100 by etching, drilling, punching, or any suitable method of forming the port for receiving attributes from an environment which the package 100 is exposed. The attributes may be acoustic signal, pressure signal, optical signal, gas signal, and any suitable signal. As illustrated, the MEMS device package 100 is a MEMS microphone package.

Although the MEMS device package 100 as depicted comprises a three piece structure, various aspects and configurations either in a single structure, a two piece structure, or more than three piece structure may be used to encapsulate one or more internal components. As an example, the lid 102 and the spacer 104 may be formed as a single structure, defines as a cover or a cap 112. One or more bonding pads 110 may be formed on at least one of the substrate 106 or the cover 112 by any suitable method for mounting the package 100 to an external printed circuit board of the client machine or another support member.

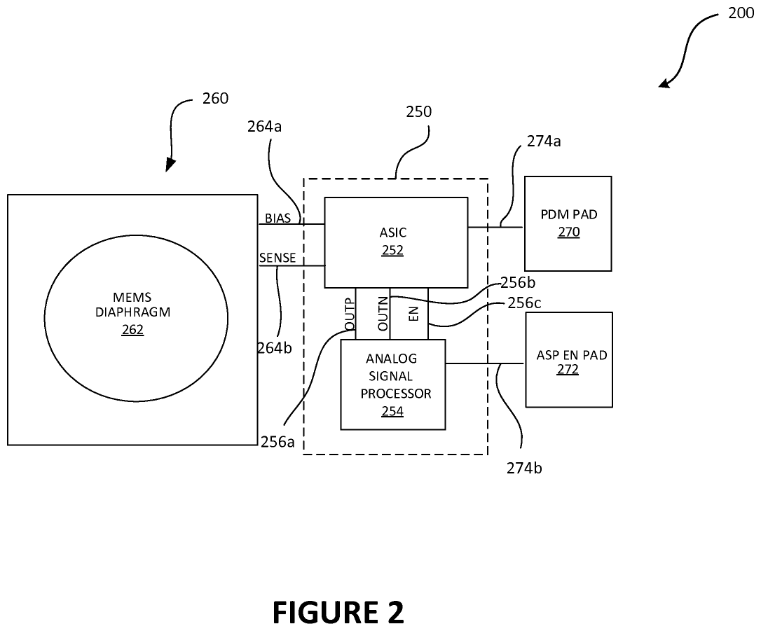

FIG. 2 is a schematic block diagram of an exemplary MEMS device package 200 with a low power sensor circuitry 250 in accordance with a described embodiment of the disclosure. The low power sensor circuitry 250 includes a sensor ASIC 252 and a processor 254 communicatively interfaced with the sensor ASIC 252 via one or more connections, three connections 256a-256c are illustrated. The processor 254 may be of any type, including but not limited to a microprocessor, a microcontroller, a digital signal processor, an analog signal processor, or any combination thereof. The processor 254 may include one or more levels of caching, such as a level cache memory, one or more processor cores, and registers. Depending on the desired configuration, the processor may be of any type, including but not limited to a microprocessor (μP), a microcontroller (μC), a digital signal processor (DSP), or any combination thereof. The processor may include one or more levels of caching, such as a level cache memory, one or more processor cores, and registers. The example processor cores may (each) include an arithmetic logic unit (ALU), a floating point unit (FPU), a digital signal processing core (DSP Core), or any combination thereof. An example memory controller may also be used with the processor, or in some implementations the memory controller may be an internal part of the processor. Depending on the application, more than one processor 254 may be disposed in the package 200. As illustrated, the processor 254 coupled to the sensor ASIC 252 is an analog signal processor (ASP). Resides in the package 200 is a MEMS sensor device 260 having at least one movable member 262 communicatively coupled to the sensor ASIC 252 via one or more connections, two connections 264a, 264b are illustrated. More than one MEMS sensor device 260 may be disposed in the package 200 and communicatively coupled to at least one or more of the sensor ASIC 252 and the processor 254. As illustrated, the MEMS sensor device is a microphone 260 and the sensor ASIC 252 coupled to the microphone 260 is a microphone ASIC. The sensor circuitry 250 is communicatively coupled to one or more terminals 270, 272 exterior to the package 200. As an example, the first and second terminals 270, 272 are one bit pulse density modulated output (PDM) bonding pad and ASP_EN bonding pad, respectively. A PDM signal is transmitted from the microphone ASIC 252 to the first terminal 270 and a single bit digital enable/disable signal is transmitted from the ASP 254 to the second terminal 272. The connectors 264a, 264b, 274a, 274b may be wire bonding, solder-bumps, solder microbumps, solder balls or any suitable connectors. Depending on the application, any suitable computer implemented modules may be coupled to the sensor device 260 and the sensor circuitry 250 via either a wired link or a wireless link. The sensor circuitry 250 will be further described below.

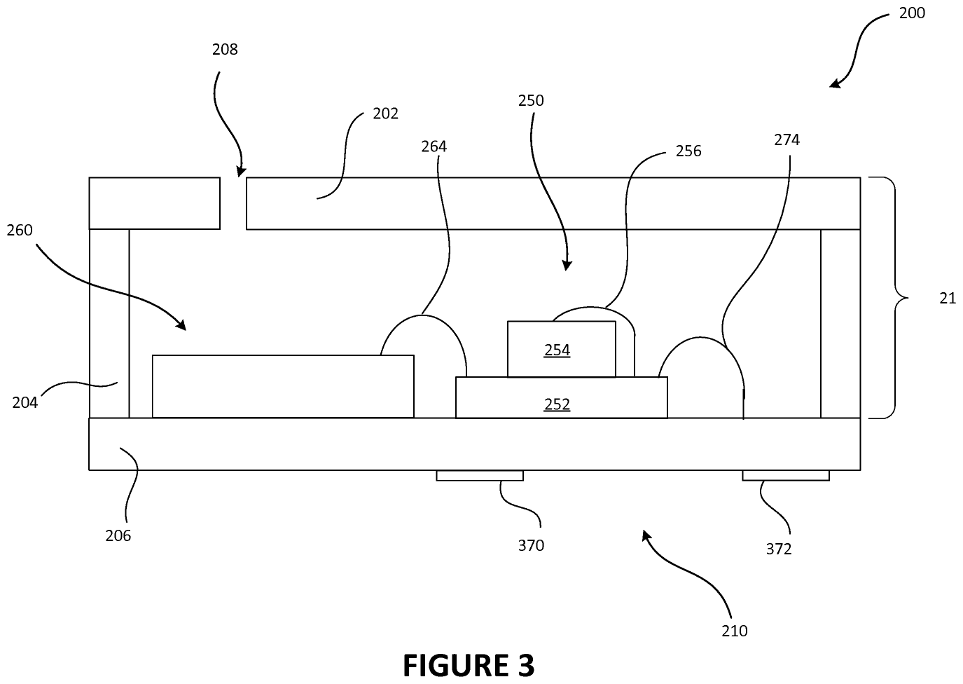

FIG. 3 illustrates a cross-sectional view of the MEMS device package 200 of FIG. 2 in accordance with a described embodiment of the disclosure. The package 200 includes a sensor device 260 adjacent to an optional inlet port 208 and is mounted on a first surface of a substrate 206. A sensor circuitry 250 communicatively coupled to the sensor device 260 via one or more connectors 264 are also mounted on the first surface of the substrate 206. A cap or cover 212 configured to encapsulate the sensor device 260 and the sensor circuitry 250 is mounted or attached to the first surface of the substrate 206 by any suitable attachment techniques. Depending on the applications, more than one sensor device 260, the sensor circuitry 250, any computer implement components, or internal components may be disposed in the package 200 and mounted on the first surface of the substrate 206. Furthermore, more than one sensor device 260 may be communicatively coupled to one or more sensor circuitries 250. In some embodiments, the sensor device 260, the sensor circuitry 250, or any suitable components may be mounted on any inner surface of the cover 212 by any suitable attachment techniques. The inlet port 208 may be formed on any location. As an example, the inlet port 208 may be formed either on top of the sensor circuitry 250 or on the bottom of the sensor circuitry 250. As another example, the inlet port 208 may be formed on a spacer 204 of the cover 212, defines as a side inlet port 208. In such case, the side inlet port 208 may be adjacent to either the sensor device 260 or the sensor circuitry 250. The sensor circuitry 250 comprises a first component 252 mounted to the first surface of the substrate 206 and a second component 254 mounted on the first component 252 in a three-dimensional chip stacked configuration. In one embodiment, additional internal component or sensor device may be mounted on the second component 254. In another embodiment, additional internal component or sensor device located next to the second component 254 may also be mounted on the first component 252. First end of a connector 256 is coupled to the first component 252 and a second end of the connector 256 is coupled to the second component 254. The first component 252, in turn, is coupled to any suitable bonding pads or terminals 210, two pads 370, 372 are illustrated, external to the package 200 via one or more connectors 274. The connectors 264, 256, 274 may be wire bonding, solder-bumps, solder microbumps, solder balls, or any suitable connectors. As illustrated, the sensor device 260, the first component 252, and the second component 254 are a microphone, a microphone ASIC, and an ASP, respectively. Other types of sensor device and internal components can be used.

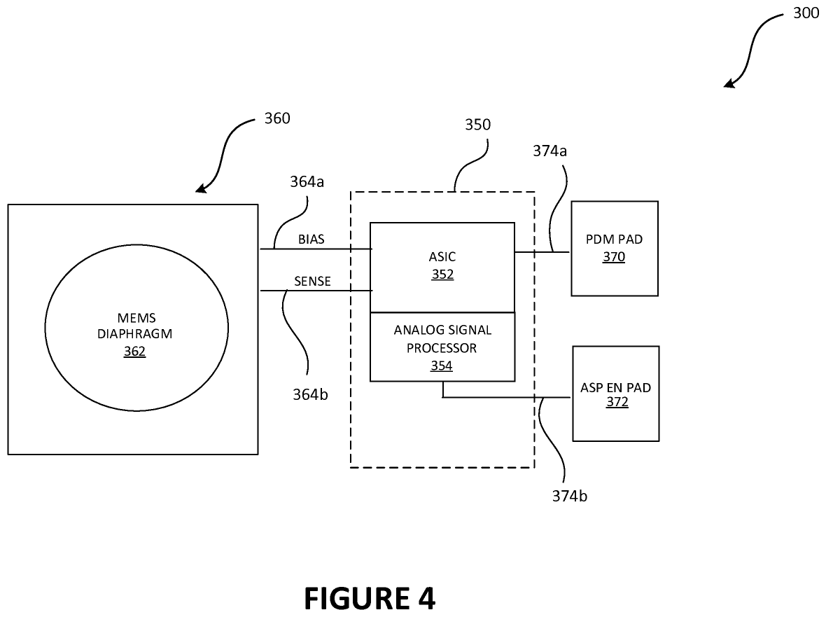

FIG. 4 is a schematic block diagram of an exemplary MEMS device package 300 with a low power sensor circuitry 350 in accordance with a described embodiment of the disclosure. Unlike from the sensor circuitry 250 of FIG. 2, a sensor ASIC 352 and processor 354 are integrated together, defines a sensor circuitry 350. More than one processor and sensor ASIC may be integrated with the sensor circuitry 350. The processor 354 may be of any type, including but not limited to a microprocessor, a microcontroller, a digital signal processor, an analog signal processor, or any combination thereof. The processor 354 may include one or more levels of caching, such as a level cache memory, one or more processor cores, and registers. Depending on the desired configuration, the processor may be of any type, including but not limited to a microprocessor (μP), a microcontroller (μC), a digital signal processor (DSP), or any combination thereof. The processor may include one or more levels of caching, such as a level cache memory, one or more processor cores, and registers. The example processor cores may (each) include an arithmetic logic unit (ALU), a floating point unit (FPU), a digital signal processing core (DSP Core), or any combination thereof. An example memory controller may also be used with the processor, or in some implementations the memory controller may be an internal part of the processor. Depending on the application, more than one processor 354 may be separately interfaced with the sensor circuitry 350 and disposed in the package 300. As illustrated, the processor 354 is an analog signal processor (ASP). Resides in the package 300 is a MEMS sensor device 360 having at least one movable member 362 communicatively coupled to the sensor ASIC 352 via one or more connections, two connections 364a, 364b are illustrated. More than one MEMS sensor device 360 may be disposed in the package 300 and communicatively coupled to the sensor circuitry 350. As illustrated, the MEMS sensor device is a microphone 260 and the sensor ASIC 352 coupled to the microphone 360 is a microphone ASIC. The sensor circuitry 350 is communicatively coupled to one or more terminals 370, 372 via connections 374a, 374b. A PDM signal is transmitted from the microphone ASIC 352 to the first terminal 370 and a single bit digital enable/disable signal is transmitted from the ASP 354 to the second terminal 372. The connectors 364a, 364b, 374a, 374b may be wire bonding, solder-bumps, solder microbumps, solder balls or any suitable connectors Depending on the application, any suitable computer implemented modules may be coupled to the sensor device 360 and the sensor circuitry 350 via either a wired link or a wireless link. The sensor circuitry 350 will be further described below.

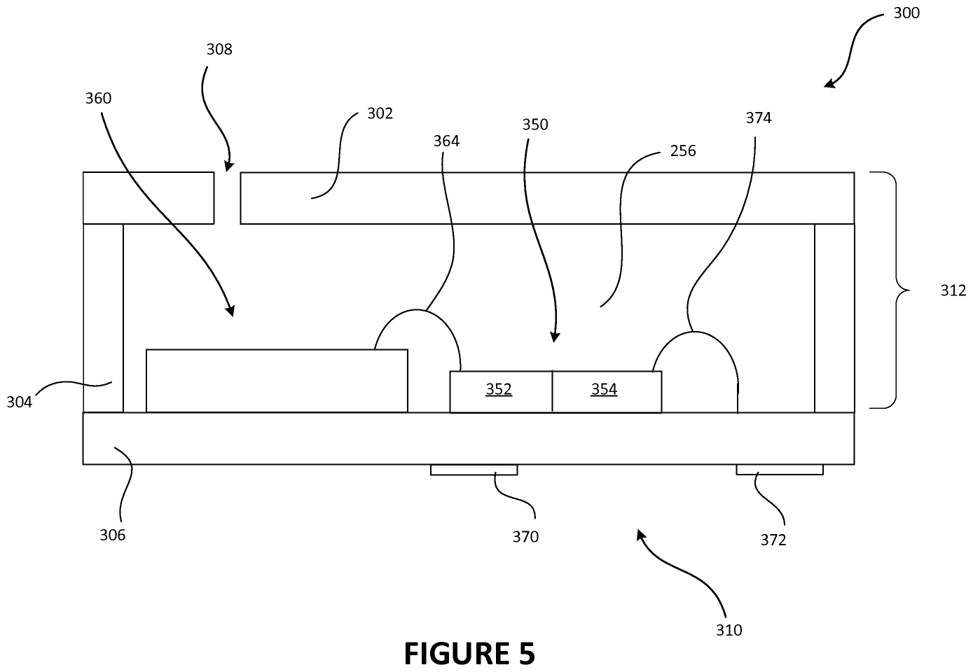

FIG. 5 illustrates a cross-sectional view of the MEMS device package 300 of FIG. 4 in accordance with a described embodiment of the disclosure. The package 300 includes a sensor device 360 adjacent to an optional inlet port 308 is mounted on a first surface of a substrate 306. A sensor circuitry 350 communicatively coupled to the sensor device 360 via one or more connectors 364 is also mounted on the first surface of the substrate 306. A cap or cover 312 configured to encapsulate the sensor device 360 and the sensor circuitry 350 is mounted or attached to the first surface of the substrate 306 by any suitable attachment techniques. Depending on the applications, more than one sensor device 360, the sensor circuitry 350, any computer implement components, or internal components may be housed in the package 300. Furthermore, more than one sensor device 360 may be communicatively coupled to one or more sensor circuitries 350. In some embodiments, the sensor device 360, the sensor circuitry 350, or any suitable components may be mounted on any inner surface of the cover 312 by any suitable attachment techniques. The inlet port 308 may be formed on any location of the package 300. As an example, the inlet port 308 may be formed either on top of or below the sensor circuitry 350. As another example, the inlet port 308 may be formed on a spacer 304 of the cover 312, defines as a side inlet port 308. In such case, the side inlet port 308 may be adjacent to either the sensor device 360 or the sensor circuitry 350. The sensor circuitry 350 comprises integrated first and second components 352, 354 mounted to the first surface of the substrate 306. In some embodiment, the first and second components 352, 354 may be mounted on the first surface of the substrate 306 in a side-by-side chip configuration. In one embodiment, additional internal component or sensor device may be disposed adjacent between the sensor device 360 and the sensor circuitry 350. In another embodiment, additional internal component or sensor device may be located in proximal to the sensor circuitry 350 and away from the sensor device 360. As depicted in FIG. 5, first end of the connector 364 is coupled to the sensor device 360 and a second end of the connector 364 is coupled to the first component 352, which in turn, coupled to a terminal 370 exterior to the package 300. The second component 354 is communicatively coupled to a terminal 372 also exterior to the package 300. As an example, the terminals 370, 372 are PDM bonding pad and ASP bonding pad, respectively. The connectors 364 and 374 may be wire bonding, solder-bumps, solder microbumps, solder balls, or any suitable connectors. As illustrated, the sensor device 360, the first component 352, and the second component 354 are a microphone, a microphone ASIC, and an ASP, respectively. Other types of sensor device and internal components can be used.

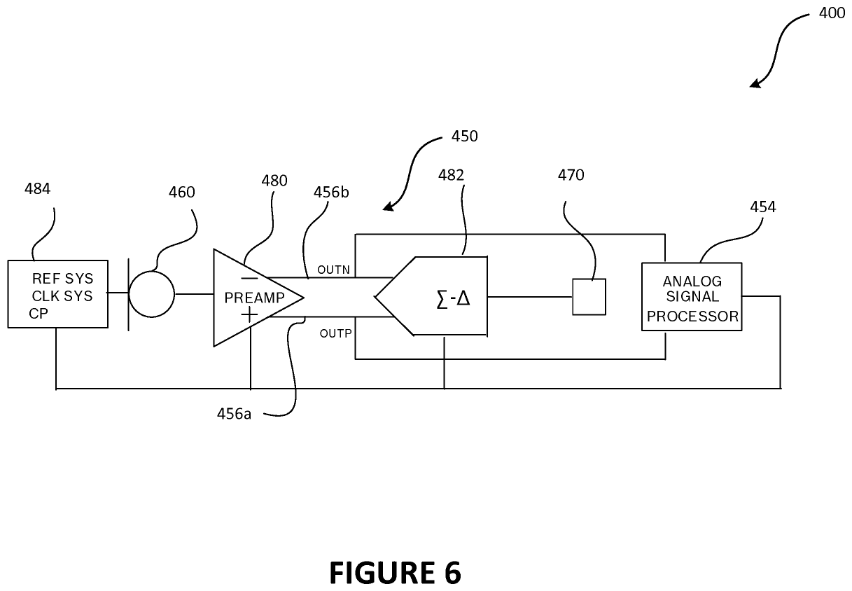

FIG. 6 is a schematic diagram of an exemplary MEMS sensor system 400. The MEMS sensor system 400, illustrated as a digital MEMS sensor system, includes a sensor device 460 and a sensor circuitry 450. An audio signal processor (ASP) 454 may be optionally integrated into the sensor circuitry 450, in one embodiment. In another embodiment, the ASP 454 as a separate component may be communicatively coupled to the sensor circuitry 450. The ASP 454 is capable of distinguishing between various audio signals or audio signature with very low power consumption. As one example, the audio signals or audio signature may be produced by an object, an event, or combination thereof. An object may be human, machines, vehicles, or any target capable of producing audio signals or audio signature. The event may be noisy environment, for example. The sensor circuitry 450 further includes a preamplifier 480, a sigma-delta modulator 482, and a sensor support circuitry 484. As illustrated, the sensor device 460 and the sensor circuitry 450 is a sensor ASIC. It will be appreciated that these elements may be implemented as various combinations of hardware and programmed software and at least one or more of these comments can be disposed on the sensor ASIC. The sigma-delta modulator 482 converts the analog signal into a digital signal. The output of the signal-delta modulator 482 is electrically coupled to a bonding pad 470, e.g. PDM bonding pad. The sensor support circuitry 484 may include at least one or more of a voltage reference, a clock system, and a charge pump. The clock system of the sensor support circuitry 484 provides various clock signals to the charge pump and can be used to control the timing during the start-up sequence for the microphone. The charge pump of the sensor support circuitry 484 provides a voltage for biasing a movable member of the sensor device 460 and the preamplifier 480 buffers the signal produced by the sensor device 460. Depending on the application, the charge pump may be replaced with a power supply that may be external to the package 400. An acoustic or voice signal impinges on the movable member causes the movable member to vibrate, in turn causes the capacitance of the sensor device changes, and voltages are created that becomes an electrical signal.

In operation, the sensor system 400 operates in a variety of different modes and several states that cover these modes. For instance, the sensor circuitry 450 is configured to operate in a low performance mode and a full performance mode. To optimize power consumption, each component is configured to operate with minimal power in the low performance mode when listening for a wake-up signal. When the ASP 454 detects audio signal or audio signature, the ASP 454 differentiates relevant audio signal or audio signature from unwanted audio signal, the ASP 454 causes other components within the sensor circuitry 450 to switch to full performance operation. In the sensor circuitry 450, the preamplifier 480 operates in full performance mode, i.e. optimal noise and distortion, and the sigma-delta modulator 482 is powered-on by the sensor support circuitry 484. Once the sensor circuitry 450 is triggered indicating relevant audio signal or audio signature is detected, the sigma-delta 482 transmits PDM data on the PDM bonding pad 470. When the audio signal or audio signature is not present, thus the ASP 454 does not detect relevant audio signal or audio signature, the ASP 454 causes other components within the sensor circuitry 450 to switch to low performance operation. In the sensor circuitry 450, the preamplifier 480 operates in low power mode and the sigma-delta modulator 482 is powered down by the sensor support circuitry 484. Since the audio signal or audio signature is not present, no data is presented nor is transmitted by the sigma delta 482. Thus, the sensor support circuitry 484 is optimized for power.

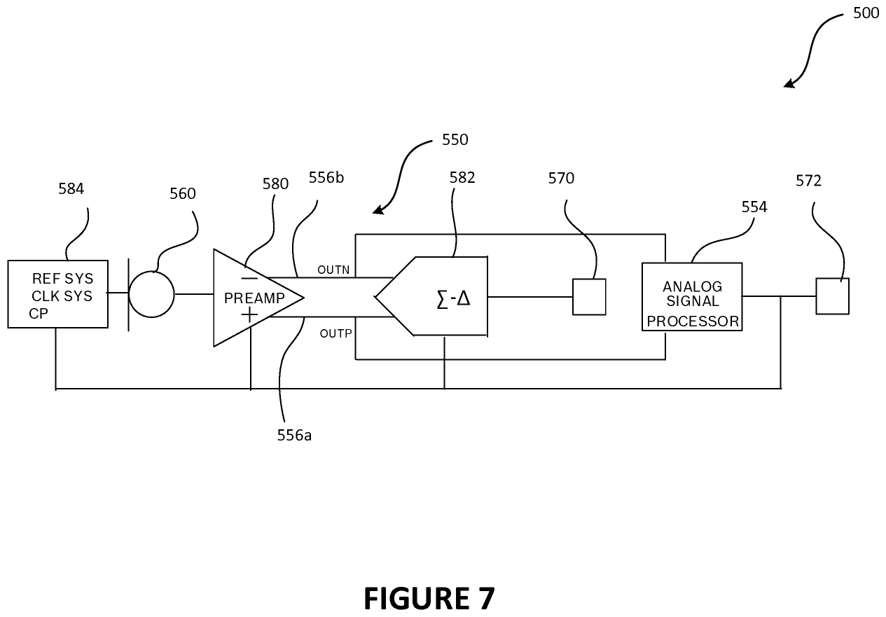

FIG. 7 is a schematic diagram of an exemplary MEMS sensor system 500. The system 500 is similar to the system 400 of FIG. 7, except that a sensor support circuitry 584 and an ASP 554 are communicatively coupled to an ASP pad 572. When audio signal or audio signature is detected by the ASP 554, a digital enable/disable signal may be output or transmitted to any components external to the MEMS sensor system 500 via the ASP bonding pad 572. In doing so, the external components and the sensor system 500 are operated either in a low power mode when no audio signal or audio signature is present or in a full performance mode when audio signal or audio signature is present and detected by the ASP 554. In low performance mode, the ASP 554 causes the external components to turn off and the preamplifer 580 is set to low performance mode which in turn powers down the sigma delta converter 582. In full performance mode, the sensor circuitry 550 causes the external components to turn on.

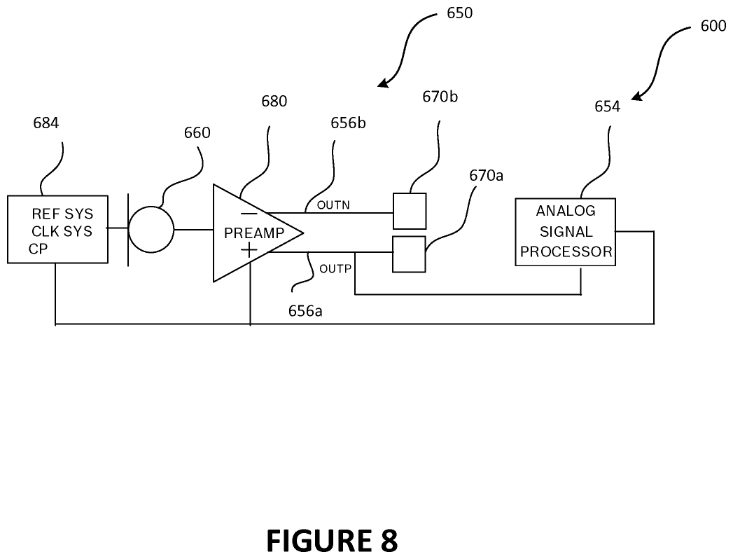

FIG. 8 is a schematic diagram of an exemplary MEMS sensor system 600. Unlike from the previous system 400 of FIG. 6, the system 600 is a differential analog MEMS sensor system 600 and thus, the sigma-delta modulator is not required. The preamplifer 680 in this example comprises two connecting links 656a, 656b electrically coupled to bonding pads 670a, 670b, respectively. The system 600 is configured to operate in a variety of different modes and several states that cover these modes. For instance, the sensor circuitry 650 is configured to operate in a low performance mode and a full performance mode. When the ASP 654 detects audio signal or audio signature and differentiates relevant audio signal or audio signature from unwanted audio signal, the ASP 654 causes other components within sensor circuitry 650 to switch to full performance operation. In the sensor circuitry 650, the preamplifier 680 operates in full performance mode, i.e. optimal noise and distortion. When the audio signal or audio signature is not present, thus the ASP 654 does not detect relevant audio signal or audio signature, the ASP 654 causes other components 684 and sensor circuitry 650 to switch to low power operation. In the sensor circuitry 650, the preamplifier 680 operates in low power mode, thus optimize the performance of the system 600.

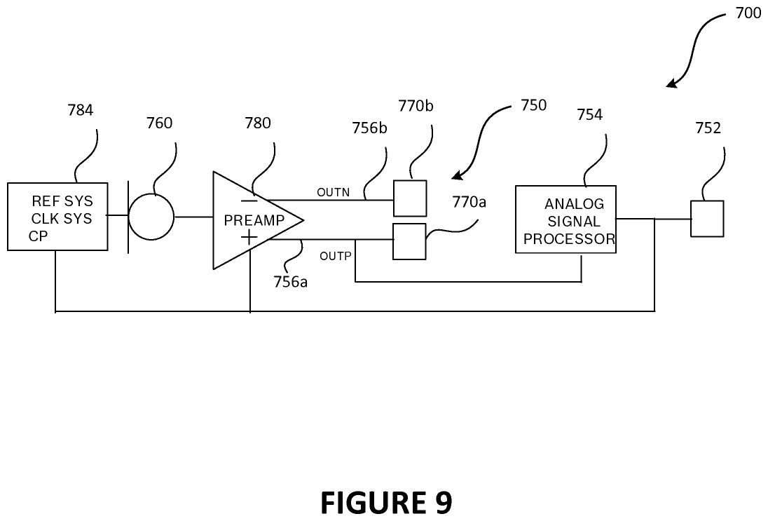

FIG. 9 is a schematic diagram of an exemplary MEMS sensor system 700. Unlike from the previous system 600 of FIG. 8, the system 700 includes a sensor support circuitry 784, an ASP 754, and an ASP bonding pad 752 communicatively coupled to both the sensor support circuitry 784 and the ASP 754. Similar to system 700, the preamplifer 780 in this example comprises two connecting links 756a, 756b electrically coupled to bonding pads 770a, 770b, respectively. Audio signal or audio signature detected by the ASP 754 may be output or transmitted to any components external to the MEMS sensor system 700. In one embodiment, the external components and the sensor system 700 can be operated either in a low performance mode when no audio signal or audio signature is present. In another embodiment, the external components and the sensor system 700 can be operated in a full performance mode when audio signal or audio signature is present and detected by the ASP 754. In low performance mode, the sensor circuitry 750 causes the external components to turn off and the preamplifier 780 of the sensor circuitry 750 is enabled in a single ended operation. In full performance mode, the sensor circuitry 750 causes the external components to turn on and the preamplifier 780 of the sensor circuitry 750 is enabled in a differential output operation.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the sprit and scope of this disclosure.

While the patent has been described with reference to various embodiments, it will be understood that these embodiments are illustrative and that the scope of the disclosure is not limited to them. Many variations, modifications, additions, and improvements are possible. More generally, embodiments in accordance with the patent have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A MEMS sensor system comprising:
a sensor device having a movable member;
a sensor circuitry communicatively coupled the sensor device to at least one or more terminals, wherein the sensor circuitry comprises:
a sensor ASIC; and
an analog signal processor coupled to least one of the sensor ASIC, the sensor device, and the terminal;
wherein the sensor ASIC is configured to operate either at a full performance mode after an audio signal is detected or at a lower performance mode when the audio signal is not detected.

2. The MEMS sensor system of claim 1 wherein the analog signal processor is configured to detect the audio signal.

3. The MEMS sensor system of claim 2 wherein the sensor circuitry comprises a preamplifier configured to output a signal indicative of acoustic pressures on the movable member.

4. The MEMS sensor system of claim 3 wherein the preamplifier is at a full performance mode after the audio signal is detected.

5. The MEMS sensor system of claim 3 wherein the preamplifier is at a lower power mode when the audio signal is not presence.

6. The MEMS sensor system of claim 3 wherein the sensor circuitry further comprises a sigma-delta modulator communicatively coupled to the preamplifier.

7. The MEMS sensor system of claim 6, wherein the preamplifier is at a full performance mode after the audio signal is detected and the sigma-delta modulator is powered-on.

8. The MEMS sensor system of claim 6, wherein the preamplifier is at a full performance mode after the audio signal is detected and the sigma-delta modulator is powered-off.

9. The MEMS sensor system of claim 1, wherein the sensor ASIC and the audio signal processor are in a three-dimensional chip stacked configuration.

10. The MEMS sensor system of claim 1, wherein the sensor ASIC and the audio signal processor are integrated into a single sensor circuitry.

11. The MEMS sensor system of claim 1, wherein the sensor device is selected from a group consisting of an electrets microphone, a silicon microphone, a capacitive microphone, and a piezoelectric microphone.

12. A sensor circuitry for a MEMS sensor device package comprising:
at least one terminal;
a sensor ASIC; and
an analog signal processor coupled to least one of the sensor ASIC and the terminal;
wherein the sensor ASIC is configured to operate either at a full performance mode after an audio signal is detected or at a lower performance mode when the audio signal is not detected.

13. The sensor circuitry of claim 12 wherein the analog signal processor is configured to detect the audio signal.

14. The sensor circuitry of claim 13 further comprises a preamplifier configured to output an audio signal indicative of acoustic pressures.

15. The sensor circuitry of claim 14 wherein the preamplifier is at a full performance mode after the audio signal is detected.

16. The sensor circuitry of claim 14 wherein the preamplifier is at a lower power mode when the audio signal is not presence.

17. The sensor circuitry of claim 14 further comprises a sigma-delta modulator communicatively coupled to the preamplifier.

18. The sensor circuitry of claim 17, wherein the preamplifier is at a full performance mode after the audio signal is detected and the sigma-delta modulator is powered-on.

19. The sensor circuitry of claim 17, wherein the preamplifier is at a full performance mode after the audio signal is detected and the sigma-delta modulator is powered-off.

20. The sensor circuitry of claim 12, wherein the sensor ASIC and the audio signal processor is in a three-dimensional chip stacked configuration.

21. The sensor circuitry of claim 12, wherein the sensor ASIC and the audio signal processor are integrated into a single sensor circuitry.

22. The sensor circuitry of claim 12, wherein a sensor device is communicatively coupled to the sensor ASIC.

23. The sensor circuit of claim 22, wherein the sensor device is selected from a group consisting of an electrets microphone, a silicon microphone, a capacitive microphone, and a piezoelectric microphone.
